(19) United States
(12) Patent Application Publication
(10) Pub. No.: US 2022/0118782 A1
(43) Pub. Date: Apr. 21, 2022

(54) DATA STREAMING OF A FLUID DISPENSING DEVICE

(71) Applicant: Hewlett-Packard Development Company, L.P., Spring, TX (US)

(72) Inventors: Daryl E. Anderson, Corvallis, OR (US); Eric T. Martin, Corvallis, OR (US)

(73) Assignee: Hewlett-Packard Development Company, L.P., Spring, TX (US)

(21) Appl. No.: 17/312,711

(22) PCT Filed: Jul. 9, 2019
(86) PCT No.: PCT/US2019/041057

§ 371 Date: Jun. 10, 2021

(51) Int. Cl. B41J 29/393

(52) U.S. Cl. CPC B41J 29/393

(57) ABSTRACT

In some examples, a fluid dispensing device component includes an interface to communicate with a fluid dispensing system, and a controller to stream data of a fluid dispensing device through the interface to the fluid dispensing system in a first time interval. In a second time interval, the controller determines whether the fluid dispensing system has provided an indication that the fluid dispensing system is to send information to the fluid dispensing device component through the interface, and in response to determining that the fluid dispensing system has not provided the indication, continues to stream data of the fluid dispensing device through the interface to the fluid dispensing system.

### BACKGROUND

A fluid dispensing system can dispense fluid towards a target. In some examples, a fluid dispensing system can include a printing system, such as a two-dimensional (2D) printing system or a three-dimensional (3D) printing system. A printing system can include printhead devices that include fluidic actuators to cause dispensing of printing fluids.

### BRIEF DESCRIPTION OF THE DRAWINGS

Some implementations of the present disclosure are described with respect to the following figures.

FIG. 1 is a block diagram of a fluid dispensing system, according to some examples.

FIG. 2 is a flow diagram of a process according to some examples.

FIG. 3 is a timing diagram showing a sequence of information over a data channel connected to an interface of a fluid dispensing device component, according to some examples.

FIG. 4 is a block diagram of a fluid dispensing device component, according to some examples.

FIG. 5 is a block diagram of a fluid dispensing system according to some examples.

FIG. 6 is a block diagram of a fluid dispensing device according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A fluid dispensing device can include fluidic actuators that when activated cause dispensing (e.g., ejection or other flow) of a fluid. For example, the dispensing of the fluid can include ejection of fluid droplets by activated fluidic actuators from respective nozzles of the fluid dispensing device. In other examples, an activated fluidic actuator (such as a pump) can cause fluid to flow through a fluid conduit or fluid chamber. Activating a fluidic actuator to dispense fluid can thus refer to activating the fluidic actuator to eject fluid from a nozzle or activating the fluidic actuator to cause a flow of fluid through a flow structure, such as a flow conduit, a fluid chamber, and so forth.

Activating a fluidic actuator can also be referred to as firing the fluidic actuator. In some examples, fluidic actuators include thermal-based fluidic actuators including heating elements, such as resistive heaters. When a heating element is activated, the heating element produces heat that can cause vaporization of a fluid to cause nucleation of a vapor bubble (e.g., a steam bubble) proximate the thermal-based fluidic actuator that in turn causes dispensing of a quantity of fluid, such as ejection from an orifice of a nozzle or flow through a fluid conduit or fluid chamber. In other examples, a fluidic actuator may be a piezoelectric membrane based fluidic actuator that when activated applies a mechanical force to dispense a quantity of fluid.

In examples where a fluid dispensing device includes nozzles, each nozzle includes a fluid chamber, also referred to as a firing chamber. In addition, a nozzle can include an orifice through which fluid is dispensed, a fluidic actuator, and a sensor. Each fluid chamber provides the fluid to be dispensed by the respective nozzle.

Generally, a fluidic actuator can be an ejecting-type fluidic actuator to cause ejection of a fluid, such as through an orifice of a nozzle, or a non-ejecting-type fluidic actuator to cause flow of a fluid.

In some examples, a fluid dispensing device can be in the form of a printhead, which can be mounted to a print cartridge, a carriage, a printbar, and so forth. In further examples, a fluid dispensing device can be in the form of a fluidic die. A “die” refers to an assembly where various layers are formed onto a substrate to fabricate circuitry, fluid chambers, and fluid conduits. Multiple fluidic dies can be mounted or attached to a support structure.

In the present disclosure, a “fluid dispensing device component” can refer to either a fluid dispensing device, or a component (e.g., an integrated circuit component) that is part of, or attached to, or coupled to the fluid dispensing device.

In some examples, a fluid dispensing device can be provided with sensors to measure various characteristics associated with the fluid dispensing device. The sensors can generate a relatively large amount of data that is to be communicated from the fluid dispensing device to a system controller of a fluid dispensing system (e.g., a printing system). The fluid dispensing device is mounted in the fluid dispensing system.

An interface of a fluid dispensing device may have a relatively slow data rate for transmitting data from the fluid dispensing device to the system controller of the fluid dispensing system. For example, if the system controller employs a polling technique to poll (request) data (e.g., sensor data acquired by sensors) of a fluid dispensing device, the throughput of data transmissions from the fluid dispensing device to the system controller may be constrained by how often the system controller can poll the fluid dispensing device for data. In other examples, the throughput of data transmissions from the fluid dispensing device to the system controller may be constrained by high overhead (e.g., in the form of address and control bits) of a protocol used for input/output (I/O) transactions between the fluid dispensing device and the system controller.

In accordance with some implementations of the present disclosure, a fluid dispensing device component is able to stream sensor data (or other types of data) through an interface of the fluid dispensing device component to a system controller of a fluid dispensing system while the system controller is not actively using the interface of the fluid dispensing device component. To allow the fluid dispensing system an opportunity to take control of the interface of the fluid dispensing device component, the streaming of data from the fluid dispensing device component can be quiesced at specified time intervals to allow the system controller to provide an indication that the system controller is to transmit information to the fluid dispensing device component. If the system controller provides the indication, the system controller can send the information through the interface to the fluid dispensing device component.

Streaming data from the fluid dispensing device component can refer to sending a continual sequence of pieces of data (e.g., data packets or other data units) to a target (e.g., the system controller in the fluid dispensing system) without the target having to first request (e.g., by polling) each piece of data.

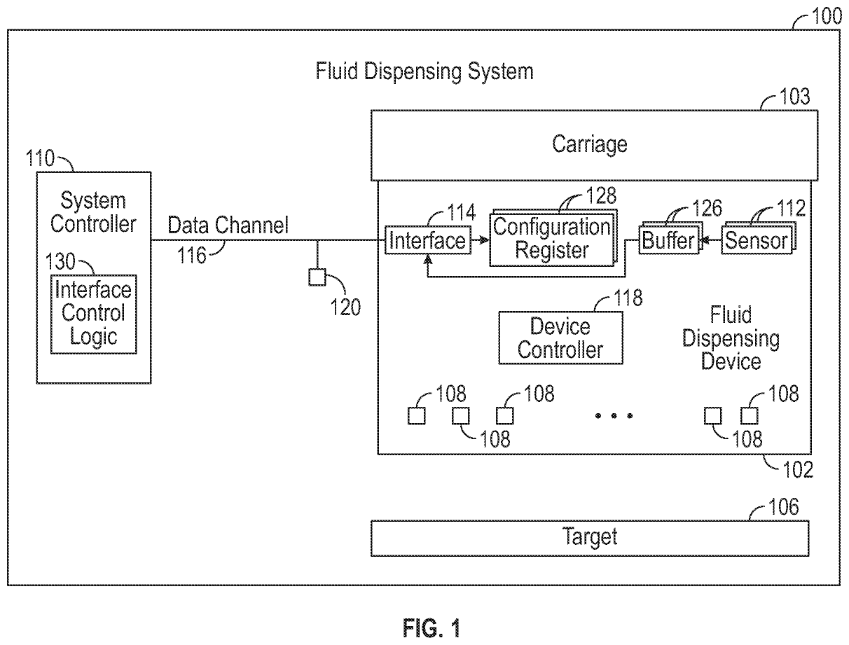

FIG. 1 is a block diagram of a fluid dispensing system 100 according to some examples. The fluid dispensing system 100 can be a printing system, such as a 2D printing system or a 3D printing system. In other examples, the fluid dispensing system 100 can be a different type of fluid dispensing system. Examples of other types of fluid dispensing systems include those used in fluid sensing systems, medical systems, vehicles, fluid flow control systems, and so forth.

The fluid dispensing system 100 includes a fluid dispensing device 102, which can be mounted to a carriage 103 (or other type of support structure) of the fluid dispensing system 100. In some examples, the fluid dispensing device 102 can be attached to a fluid cartridge (e.g., a print cartridge) that is removably mounted to the carriage 103. In other examples, the fluid dispensing device 102 can be fixedly mounted to the carriage 103.

The fluid dispensing device 102 includes orifices for dispensing fluid towards a target 106. In some examples, the carriage 103 and the target 106 are moveable with respect to one another (either the carriage 103 is moveable or the target 106 is moveable or both the carriage 103 and the target 106 are moveable).

In a 2D printing system, the fluid dispensing device 102 includes a printhead that ejects printing fluid (e.g., ink) onto a print medium, such as a paper medium, a plastic medium, and so forth.

In a 3D printing system, the fluid dispensing device 102 includes a printhead that can eject any of various different liquid agents onto a print target, where the liquid agents can include any or some combination of the following: ink, an agent used to fuse or coalesce powders of a layer of build material, an agent to detail a layer of build material (such as by defining edges or shapes of the layer of build material), and so forth. In a 3D printing system, a 3D target is built by depositing successive layers of build material onto a build platform of the 3D printing system. Each layer of build material can be processed using the printing fluid from a printhead to form the desired shape, texture, and/or other characteristic of the layer of build material.

The fluid dispensing device 102 can include an array of fluidic actuators 108. In some examples, the fluidic actuators 108 are part of nozzles including orifices for ejecting fluid to the target 106 when the fluidic actuators 108 are activated (fired). The array of fluidic actuators 108 can include a column of fluidic actuators, or multiple columns of fluidic actuators. In other examples, the fluidic actuators 108 can be used to move fluid through fluid conduits of the fluid dispensing device 102, instead of ejecting fluids through orifices to the target 106.

Each fluidic actuator 108 is selected by a respective different address provided by a controller (e.g., a system controller 110) in the fluid dispensing system 100. The system controller 110 is separate from and external of the fluid dispensing device 102. As used here, a “controller” can refer to a hardware processing circuit, which can include any or some combination of a microprocessor, a core of a multi-core microprocessor, a microcontroller, a programmable integrated circuit (e.g., application programmable integrated circuit (ASIC), etc.), a programmable gate array, a digital signal processor, a number of discrete hardware components (e.g., timers, counters, state machines, etc.), or another hardware processing circuit. A controller can also include discrete components such as timers, counters, state machines, latches, buffers, and so forth. Alternatively, a “controller” can refer to a combination of a hardware processing circuit and machine-readable instructions (software and/or firmware) executable on the hardware processing circuit.

Although FIG. 1 shows the system controller 110 as being one block, it is noted that the system controller 110 can actually represent multiple controllers that perform respective tasks. For example, the system controller 110 can be implemented using multiple ASICs, where one ASIC can be deployed on the carriage 103, and another ASIC can be a main ASIC for controlling fluid dispensing operations (e.g., printing operations).

The fluid dispensing device 102 also includes sensors 112 to sense various characteristics associated with the fluid dispensing device 102. As examples, the sensors 112 can include any or some combination of the following: a strain gauge to measure strain on the fluid dispensing device 102, a thermal sensor to measure temperature, a fluid property sensor to measure a property of a fluid, a sensor to detect a condition of an orifice (e.g., whether the orifice is blocked), a sensor to detect physical damage of the fluid dispensing device 102, and so forth. Although example types of sensors are listed, it is noted that in other examples, the sensors 112 can include alternative or additional sensors.

The fluid dispensing device 102 also includes an interface 114 through which sensor data from the sensors 112 can be streamed over a data channel 116 to the system controller 110.

In some examples, the interface 114 can include a serial interface through which information is provided over a single signal line of the data channel 116. In other examples, the interface 114 can connect to multiple signal lines of the data channel 116 in parallel to communicate multiple information bits in parallel over the data channel 116 with the system controller 110.

Although reference is made to streaming sensor data through the interface 114 to the system controller 110, it is noted that other types of data of the fluid dispensing device 102 can be streamed through the interface 114 to the system controller 110.

In addition to being able to stream sensor data from the sensors 112 to the system controller 110, the interface 114 can also be used to communicate information from the system controller 110 over the data channel 116 to the fluid dispensing device 102. For example, the information provided by the system controller 110 to the fluid dispensing device 102 can include an instruction from the system controller 110. Examples of instructions that can be sent by the system controller 110 to the fluid dispensing device 102 include any or some combination of the following: an instruction to set an identifier of the fluid dispensing device 102; an instruction to set control bits related to test modes; an instruction to set trimming (or offset) values related to analog measurements; an instruction requesting values of parameters, such as values from specific sensors; an instruction requesting a fault status; an instruction requesting specific actions for the fluid dispensing device 102 to perform, such as nozzle health assessments; an instruction setting thermal thresholds or fault points; an instruction setting actuator firing energy levels; an instruction setting thermal measurement calibration settings; an instruction reading non-volatile memory (NVM) on the die; and an instruction setting measurement settings (e.g., sense current levels, analog-to-digital gain settings, etc.).

In other examples, the system controller 110 can send other information through the interface 114 to the fluid dispensing device 102.

A time period during which the system controller 110 does not have information to send to the fluid dispensing device 102 through the interface 114 can be considered an idle time period with respect to use by the system controller 110 of the interface 114 of the fluid dispensing device 102. During idle time periods, a device controller 118 in the fluid dispensing device 102 can cause streaming of data, including sensor data from the sensors 112, through the interface 114 and over the data channel 116 to the system controller 110, or to another target component in the fluid dispensing system 100.

In the ensuing discussion, reference is made to streaming data from the fluid dispensing device 102 through the interface 114 to the system controller 110. It is noted that techniques or mechanisms according to some implementations of the present disclosure can also be applied to examples where the data of the fluid dispensing device 102 is streamed through the interface 114 to a different target component in the fluid dispensing system 100.

The device controller 118 can cause streaming of data of the fluid dispensing device 102 through the interface 114 to the system controller 110 as a default mode of operation unless the system controller 110 provides an indication that the system controller 110 has information to send to the fluid dispensing device 102 through the interface 114.

As an example, a pull-down device 120 can be connected to the data channel 116. The pull-down device 120 can be implemented as a resistor, for example. In some examples, the pull-down device 120 can be connected to ground or other reference voltage. The pull-down device 120 can be a relatively weak pull-down device (e.g., a pull-down resistor having a relatively high resistance). In the absence of any active driving of the data channel 116, the pull-down device 120 can cause the data channel 116 to be pulled to a low state.

During specified time intervals in which streaming of data by the fluid dispensing device 102 over the data channel 116 is quiesced (i.e., data is not being actively transmitted by the fluid dispensing device 102 though the interface 114), the system controller 110 is able to selectively provide an indication that the system controller 110 is to send information to the fluid dispensing device 102. In the example where the pull-down device 120 is used, the indication can be provided by the system controller 110 by driving the data channel 116 to a high state, which overcomes the pull-down effect of the pull-down device 120.

In some examples, the driving of the data channel 116 to the high state can be performed by an interface control logic 130 in the system controller 110. The interface control logic 130 can be implemented as a portion of the hardware of the system controller 110, or as instructions executable on the system controller 110.

The high state of the data channel 116 is detected by the device controller 118 through the interface 114. The device controller 118 can detect this high state of the data channel 116 as the indication that the system controller 110 is to send information to the fluid dispensing device 102.

In different examples, instead of using the pull-down device 120, a pull-up device can be used to pull the data channel 116 to a high state, unless driven to a low voltage by the interface control logic 130 of the system controller 110.

In other examples, instead of using a pull-down device or pull-up device in conjunction with the interface control logic 130 to provide indicators of whether or not the system controller 110 is to send information to the fluid dispensing device 102, the interface 114 can include a separate control input that allows the system controller 110 to provide a control indication (e.g., a data bit set to a first state or a second state depending on whether or not the system controller 110 is to send information to the fluid dispensing device 102).

In some examples, sensor data from the sensors 112 can be temporarily stored in respective buffers 126. In other examples, the buffers 126 are omitted.

The data in the buffers 126 can be provided to the interface 114 for output as a stream of sensor data to the system controller 110.

If the device controller 118 receives the indication from the system controller 110 that the system controller 110 is to send information to the fluid dispensing device 102, the device controller 118 can cause the buffers 126 to be isolated from the interface 114. For example, switches can be provided between the outputs of the buffers 126 and the interface 114, with the device controller 118 selectively controlling the switches to either connect the outputs of the buffers 126 to the interface 114, or to isolate the outputs of the buffers 126 from the interface 114. In other examples, the buffers 126 can have outputs that can be tri-stated (i.e., set to a condition where the buffers 126 present a high resistance output) under control of the device controller 118.

In some examples, information from the system controller 110 can be communicated over the data channel 116 through the interface 114 to a configuration register 128 (or multiple configuration registers) in the fluid dispensing device 102. The information provided to the configuration register 128 can be used by the fluid dispensing device 102 to perform respective operations. For example, if the information provided by the system controller 110 includes an instruction, then the instruction provided to the configuration register 128 may cause the fluid dispensing device 102 to perform an action specified by the instruction. In other examples, the information provided by the system controller 110 to the configuration register 128 can include a different type of data.

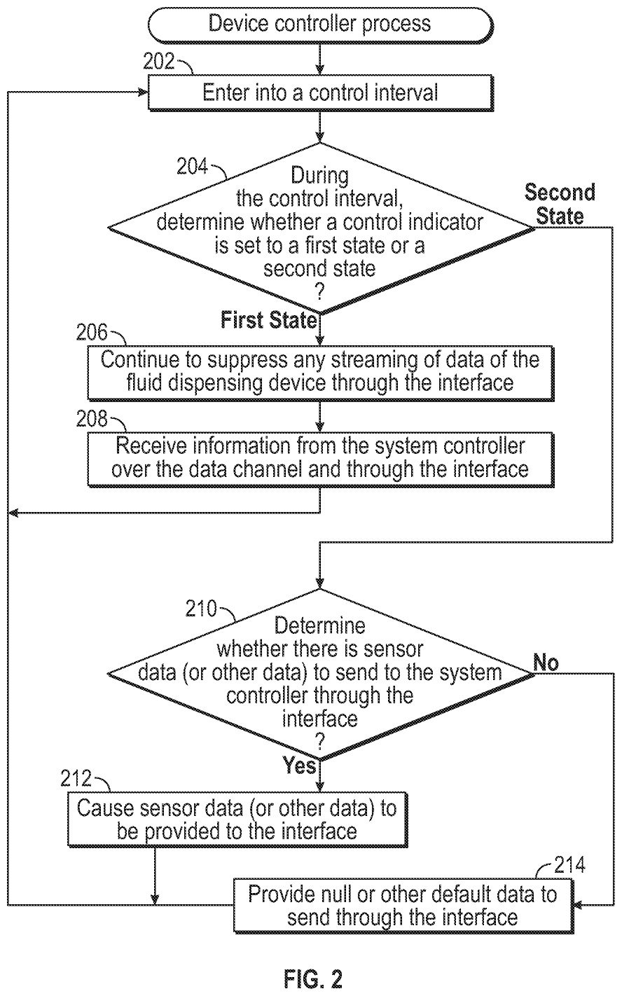

FIG. 2 is a flow diagram of a process that can be performed by the device controller 118 according to some examples. The device controller 118 enters (at 202) into a control interval, which is a time interval during which the fluid dispensing device 102 is not streaming data out through the interface 114. The device controller 118 enters the control interval by quiescing the streaming of data out through the interface 114, such as by disconnecting the outputs of the buffers 126 from the interface 114, or by tri-stating the outputs of the buffers 126. In examples where buffers 126 are not included, the device controller 118 enters the control interval by disconnecting the sensors 112 (or other sources of data) from the interface 114.

In some examples, control intervals can occur at periodic time intervals. Thus, after streaming of a specified number of pieces of data containing data of the fluid dispensing device 102, the device controller 118 can cause the streaming of data to be quiesced, so that a control interval can be provided during which the system controller 110 can set a state of a control indicator.

During the control interval, the device controller 118 determines (at 204) whether the control indicator is set to a first state (which indicates that the system controller 110 has information to send to the fluid dispensing device 102), or a second state indicating that the system controller 110 does not have information to send to the fluid dispensing device 102.

If the control indicator is set at the first state, then the device controller 118 continues (at 206) to suppress any streaming of data of the fluid dispensing device 102 through the interface 114, such as by disconnecting the outputs of the buffers 126 or the sensors 112 (or other data sources) from the interface 114.

By suppressing the streaming of data from the fluid dispensing device 102 through the interface 114, the fluid dispensing device 102 is able to receive (at 208) information from the system controller 110 over the data channel 116 and through the interface 114. The information provided by the system controller 110 can be part of a transaction according to a specified protocol over the data channel 116. The information provided by the system controller 110 can be stored in the configuration register 128, for example.

If the device controller 118 determines that the control indicator is set to the second state, then the device controller 118 determines (at 210) whether there is sensor data (or other data) to send to the system controller 110 through the interface 114. If so, the device controller 118 causes (at 212) sensor data (or other data) to be provided to the interface 114, such as from the buffers 126 or directly from the sensors 112 (or other data sources).

However, if the device controller 118 determines (at 210) that there is no sensor data (or other data) to send, the device controller 118 can provide (at 214) null or other default data to send through the interface 114. The null or other default data can have a specified value that the system controller 110 can recognize as invalid data.

In some examples, data that is transmitted by the fluid dispensing device 102 through the interface 114 can be in the form of sensor-address/data (SAD) pairs. An SAD pair includes an identifier of a sensor (e.g., an address or other identifier of the sensor) as well as sensor data produced by the sensor.

In some examples, to send data (e.g., sensor data), the device controller 118 can first send a start sequence (which includes a specified pattern of zero or more bits), followed by piece(s) of data (e.g., SAD pair(s)). Each piece of data can have a specified length.

The process of FIG. 2 then returns to task 202.

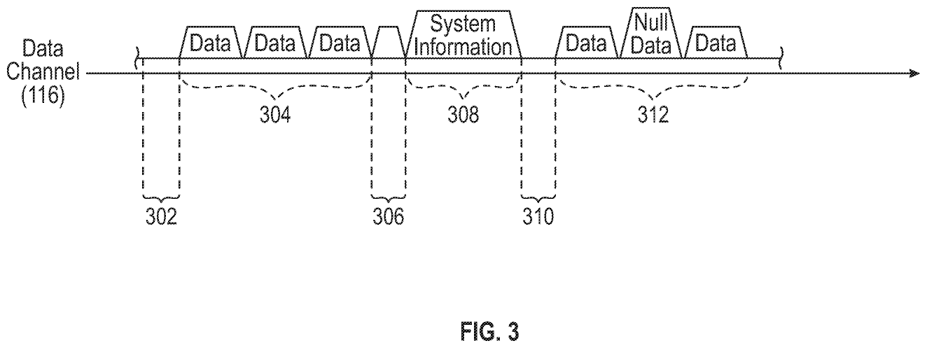

FIG. 3 is a timing diagram showing states of the data channel 116.

In a control interval 302, the control indicator has a low state, which is an example of the second state of the control indicator discussed above. The low state of the control indicator indicates that the system controller 110 does not have information to send to the fluid dispensing device 102. As an example, the control indicator is set to the low state if the system controller 110 does not actively drive the data channel 116, and the pull-down device 120 is able to pull the data channel 116 low.

In response to the low state of the control indicator detected by the device controller 118 during the control interval 302, the device controller 118 can cause a stream 304 of data to be transmitted through the interface 114. Although the stream 304 in the example of FIG. 3 includes three pieces of data (e.g., three SAD pairs), in other examples, the stream 304 can include a different number (one or greater than one) of pieces of data of the fluid dispensing device 102. The number of pieces of data included in each stream of data determines the periodicity of the control intervals during which the system controller 110 can selectively set the control indicator to the first or second state.

In the next control interval 306 after the stream 304 of data, the system controller 110 can set the control indicator to a high state, which is an example of the first state discussed above. The high state of the control indicator indicates that system controller 110 has information to send to the fluid dispensing device 102.

Following the control interval 306 in which the system controller 110 has set the control indicator to the high state, the system controller 110 sends system information 308 in a transaction over the data channel 116 to the interface 114 of the fluid dispensing device 102.

Since the transaction is according to a specified protocol, the device controller 118 of the fluid dispensing device 102 is aware of when the end of the transaction occurs.

The system information 308 can include an instruction (or multiple instructions), for example, to cause the fluid dispensing device to perform the respective operation(s).

Once the transaction in which the system information 308 is transmitted has completed, a next control interval 310 is provided during which the system controller 110 has the opportunity to set the control indicator to the first state or the second state.

Assuming the control indicator is set to the low state in the control interval 310, another stream 312 of data is provided. Note that in the stream 312 of data, one of the pieces of data includes null data which is sent if there is no valid data of the fluid dispensing device 102 to send.

The process of FIG. 3 can continue with control intervals provided periodically to allow the fluid dispensing system 100 to take control of the interface 114 of the fluid dispensing device 102.

With the ability to stream data of the fluid dispensing device 102 through the interface 114 while providing opportunities for the system controller 110 to take control of the interface 114 at specified time intervals (the control intervals discussed above), transmission of data of the fluid dispensing device 102 through the interface 114 can proceed at a relatively high rate, which still allowing the system controller 110 to send information to the fluid dispensing device 104.

The system controller 110 does not have to make determinations of when to poll data of the fluid dispensing device 102, which frees up processing resources of the system controller 110 to perform other actions, such as to send print data to the fluid dispensing device 102 to perform fluid dispensing operations.

In FIG. 1, it is assumed that the device controller 118 and the interface 114 are part of the fluid dispensing device 102. In other examples, the device controller 118 and the interface 114 (and possibly other components) can be part of a fluid dispensing device component, such as an ASIC device or other type of device.

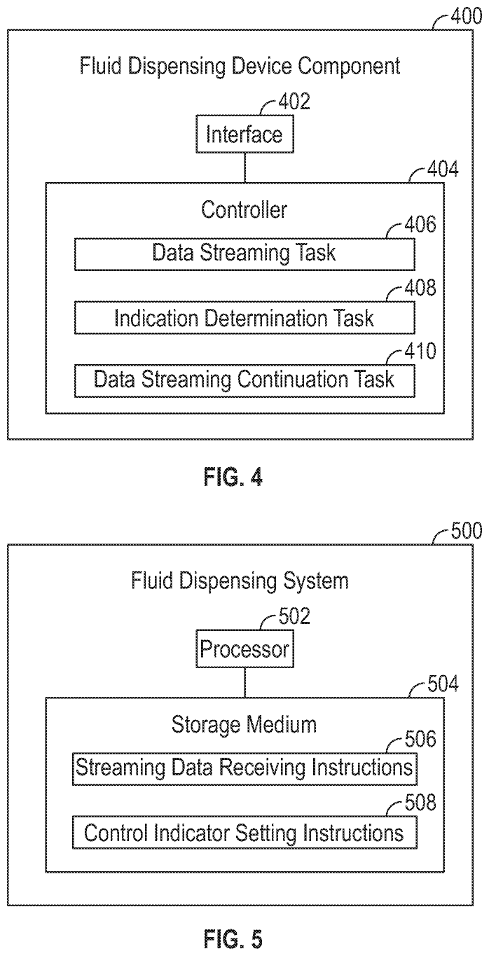

FIG. 4 is a block diagram of a fluid dispensing device component 400 that includes an interface 402 (e.g., the interface 114 of FIG. 1) to communicate with a fluid dispensing system (e.g., 100 in FIG. 1). The fluid dispensing device component 400 further includes a controller 404 (e.g., the device controller 118 of FIG. 1).

The controller 404 can perform various tasks. The controller 404 can perform a data streaming task 406 that streams data of a fluid dispensing device through the interface 402 to the fluid dispensing system in a first time interval. In some examples, the streaming data of the fluid dispensing device through the interface 402 to the fluid dispensing system is performed without a polling request from the fluid dispensing system to the fluid dispensing device component 400.

In a second time interval, the controller 404 performs an indication determination task 408 to determine whether the fluid dispensing system has provided an indication that the fluid dispensing system is to send information to the fluid dispensing device component through the interface 402.

The controller 404 further performs a data streaming continuation task 410 to, in response to determining that the fluid dispensing system has not provided the indication, continue to stream data of the fluid dispensing device through the interface 402 to the fluid dispensing system.

In some examples, the controller 404 interrupts streaming of data of the fluid dispensing device (by quiescing the streaming of data as discussed above) in the second time interval to provide an opportunity to the fluid dispensing system to take control of the interface 402.

In some examples, the data streamed through the interface 402 to the fluid dispensing system includes a data packet including sensor data of a given sensor of multiple sensors, and an identifier of the given sensor. For example, the data packet can include an SAD pair as discussed above.

FIG. 5 is a block diagram of a fluid dispensing system 500 according to some examples. The fluid dispensing system 500 includes a hardware processor 502 (or multiple hardware processors). A hardware processor can include a microprocessor, a core of a multi-core microprocessor, a microcontroller, a programmable integrated circuit, a programmable gate array, a digital signal processor, or another hardware processing circuit.

The fluid dispensing system 500 further includes a storage medium 504 storing machine-readable instructions executable on the hardware processor 502 to perform various tasks. Machine-readable instructions executable on a hardware processor can refer to the instructions executable on a single hardware processor or the instructions executable on multiple hardware processors.

The machine-readable instructions include streaming data receiving instructions 506 to receive streamed data through an interface from a fluid dispensing device.

The machine-readable instructions include control indicator setting instructions 508 to, periodically at specified time intervals during which streaming of data through the interface from the fluid dispensing device is quiesced, selectively set a control indicator of the interface to one of a first state or a second state, the control indicator settable to the first state (a “specified state”) to indicate when the fluid dispensing system has information to send to the fluid dispensing device, and the control indicator settable to the second state to indicate when the fluid dispensing system does not have information to send to the fluid dispensing device.

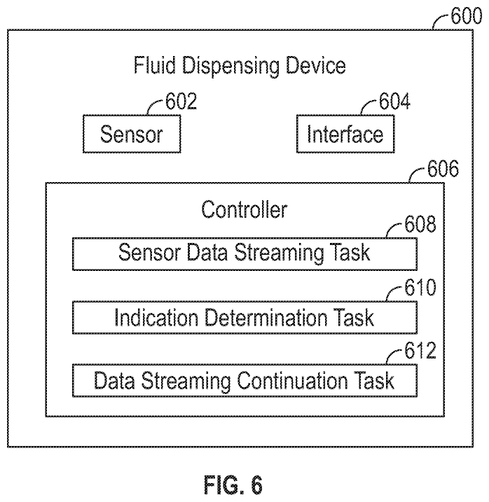

FIG. 6 is a block diagram of a fluid dispensing device 600 according to some examples. The fluid dispensing device 600 includes a sensor 602 (or multiple sensors). The fluid dispensing device 600 further includes an interface 604 to communicate with a fluid dispensing system.

The fluid dispensing device 600 further includes a controller 606 to perform various tasks. The controller 606 can perform a sensor data streaming task 608 to stream sensor data from the sensor through the interface to the fluid dispensing system in a first time interval.

The controller 606 can perform an indication determination task 610 to, in a second time interval during which streaming of sensor data is quiesced, determine whether the fluid dispensing system has provided an indication that the fluid dispensing system is to send information to the fluid dispensing device component through the interface.

The controller 606 can perform a data streaming continuation task 612 to, in response to determining that the fluid dispensing system has not provided the indication, continue to stream data of the fluid dispensing device through the interface to the fluid dispensing system.

A storage medium (e.g., 400 in FIG. 4 or 504 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disc (CD) or a digital video disc (DVD); or another type of storage device (e.g., non-transitory storage media). Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A fluid dispensing device component comprising:
an interface to communicate with a fluid dispensing system; and
a controller to:
stream data of a fluid dispensing device through the interface to the fluid dispensing system in a first time interval,
in a second time interval, determine whether the fluid dispensing system has provided an indication that the fluid dispensing system is to send information to the fluid dispensing device component through the interface, and
in response to determining that the fluid dispensing system has not provided the indication, continue to stream data of the fluid dispensing device through the interface to the fluid dispensing system.

2. The fluid dispensing device component of claim 1, wherein the controller interrupts streaming of data of the fluid dispensing device in the second time interval to provide an opportunity to the fluid dispensing system to take control of the interface.

3. The fluid dispensing device component of claim 1, wherein streaming the data of the fluid dispensing device comprises streaming sensor data from a sensor of the fluid dispensing device through the interface to the fluid dispensing system.

4. The fluid dispensing device component of claim 1, wherein streaming the data of the fluid dispensing device through the interface to the fluid dispensing system comprises streaming sensor data from a plurality of sensors through the interface to the fluid dispensing system.

5. The fluid dispensing device component of claim 4, wherein the data streamed through the interface to the fluid dispensing system comprises a first data packet comprising sensor data of a first sensor of the plurality of sensors, and an identifier of the first sensor.

6. The fluid dispensing device component of claim 1, wherein the second time interval is a periodic time interval in which the fluid dispensing system has an opportunity to take control of the interface to send the information to the fluid dispensing device component through the interface.

7. The fluid dispensing device component of claim 1, wherein the interface is connectable to a signal line, and the indication comprises the signal line being driven to a specified state.

8. The fluid dispensing device component of claim 1, wherein the controller is to:
in response to determining that the fluid dispensing system has provided the indication:
stop streaming data of the fluid dispensing device, and receive the information from the fluid dispensing system through the interface.

9. The fluid dispensing device component of claim 8, wherein the information from the fluid dispensing system comprises an instruction from the fluid dispensing system for the fluid dispensing device to perform an operation.

10. The fluid dispensing device component of claim 1, wherein streaming data of the fluid dispensing device through the interface to the fluid dispensing system is performed without a polling request from the fluid dispensing system to the fluid dispensing device component.

11. A fluid dispensing system comprising:
a processor; and
a non-transitory storage medium storing instructions executable on the processor to:
receive streamed data through an interface from a fluid dispensing device, and
periodically at specified time intervals during which streaming of data through the interface from the fluid dispensing device is quiesced, selectively set a control indicator of the interface to one of a first state or a second state, the control indicator settable to the first state to indicate when the fluid dispensing system has information to send to the fluid dispensing device, and the control indicator settable to the second state to indicate when the fluid dispensing system does not have information to send to the fluid dispensing device.

12. The fluid dispensing system of claim 11, wherein the instructions are executable on the processor to set the control indicator to the first state, and to send the information to the fluid dispensing device through the interface.

13. The fluid dispensing system of claim 11, wherein the streamed data received through the interface from the fluid dispensing device comprises sensor data from a sensor in the fluid dispensing device.

14. A fluid dispensing device comprising:
a sensor;
an interface to communicate with a fluid dispensing system; and
controller to:
stream sensor data from the sensor through the interface to the fluid dispensing system in a first time interval,
in a second time interval during which streaming of sensor data is quiesced, determine whether the fluid dispensing system has provided an indication that the fluid dispensing system is to send information to the fluid dispensing device through the interface, and
in response to determining that the fluid dispensing system has not provided the indication, continue to stream data of the fluid dispensing device through the interface to the fluid dispensing system.

15. The fluid dispensing device of claim 14, wherein the interface comprises a serial interface.
